(19) United States
(12) Patent Application Publication
(10) Pub. No.: US 2007/0147656 A1
(43) Pub. Date: Jun. 28, 2007

(54) METHOD AND SYSTEM TO PROVIDE SUPPORT FOR DIGITAL WATERMARKS IN A DATABASE

(76) Inventor: James Browning, Columbia, SC (US)

Correspondence Address: Harden E. Stevens, III;Intellectual Property Section, Law Department, NCR Corporation, 1700 South Patterson Blvd., Dayton, OH, 45479-0001, US

(21) Appl. No.: 11/608,925

(22) Filed: Dec. 11, 2006

Related U.S. Application Data
(60) Provisional application No. 60/753,243, filed on Dec. 22, 2005.

(51) Int. Cl. G06K 9/00

(52) U.S. Cl. 382/100

(57) ABSTRACT

A method, computer program and database system are disclosed for protecting data using a relational database management system supporting digital watermarking. The support for digital watermarking in a database provides an additional means for protecting copyrighted data. Having the support built-in to a database simplifies the development of applications that manage the copyrighted data and provide an extra level of security and traceability for the data once it leaves the database.

### CROSS-REFERENCE TO RELATED APPLICATION

This application claims the priority of U.S. Provisional Patent Application No. 60/753,243, filed Dec. 22, 2005, the entire contents of which are hereby incorporated by reference.

### TECHNICAL FIELD

The system described herein relates to Relational Database Management Systems (RDBMS) that support Digital Watermarks.

### BACKGROUND

Digital watermarking is one technology that has been adapted as a solution for copyright protection of digital data. Content providers have adopted this technology in order to better protect digital data from unauthorized redistribution or use. A digital watermark is an identification code and/or other information that is imbedded within digital data. The digital watermark can contain copyright information that is used to determine the owner of the data and whether the data has been illegally distributed or misused. The digital watermark information is imbedded within the data and intended to be undetectable by human senses. The digital watermark is further constructed such that any attempt to remove the watermark would likely result in a significant degradation in the quality of the data. In most cases, a good digital watermark will remain detectable in data even after the quality of the data has degraded to a point where the manipulated data is no longer useful.

Relational database management systems (RDBMS) are used to store and manage large amounts of data and it is quite common for some or all of this data to be copyrighted. Copyrighting the data affords to the owner certain legal rights to decide who and how the data is used. In some cases, it may be desirable to provide data to the public with no restrictions on its use. In such cases, a copy of the data may be extracted from a database and distributed freely. In other cases, it may be desirable to place restrictions on how data is used and/or who can use it. Traditional database security mechanisms can provide protection for data and force compliance with copyright restrictions, but only while the data remains within the database. Once data has been distributed outside of the database (e.g., data accessible over the Internet), the traditional data security mechanisms have little if any ability to enforce copyright restrictions. In these cases, the use of digital watermarking can provide an additional mechanism to protect the data and the rights of the copyright owner.

### SUMMARY

In general, one embodiment in the detailed description features a method for protecting copyrighted data by adding support for digital watermarking to a relational database management system (RDBMS) or any other type of database that supports data that can be digitally watermarked. The support for digital watermarking comprises: 1) detecting the presence of a digital watermark in received data, 2) recovering information embedded in a digital watermark, 3) adding a digital watermark to data being retrieved, and 4) adding a digital watermark to stored data that includes dynamic information. Additionally, the embodiment supports one or more digital watermarking techniques.

In general, one embodiment in the detailed description features a computer program, stored on a tangible storage medium, for use in supporting digital watermarking of data stored in a database as it executes one or more requests. The program includes executable instructions that cause a computer to provide support for digital watermarking of data stored in the database. The support for digital watermarking comprises: 1) detecting the presence of a digital watermark in received data, 2) recovering information embedded in a digital watermark, 3) adding a digital watermark to data being retrieved, and 4) adding a digital watermark to stored data that includes dynamic information. Additionally, the embodiment supports one or more digital watermarking techniques.

In general, one embodiment in the detailed description features a database system implemented on a parallel processing system, which includes one or more nodes, with one or more processors, where each of the one or more nodes provides the one or more processors with access to a data storage facility containing instructions for execution by the one or more processors and that when executed implement the database system. The database system has support for digital watermarking of data stored in the database system. The support for digital watermarking comprises: 1) detecting the presence of a digital watermark in received data, 2) recovering information embedded in a digital watermark, 3) adding a digital watermark to data being retrieved, and 4) adding a digital watermark to stored data that includes dynamic information. Additionally, the embodiment supports one or more digital watermarking techniques.

### BRIEF DESCRIPTION OF THE DRAWINGS

FIGS. 1A and 1B are block diagrams of a computer system used to implement an RDBMS.

FIG. 2 is a block diagram of the RDBMS as part of a data distribution system.

FIG. 3 is a diagram of a table in the RDBMS.

FIG. 4 is a flow chart that illustrates receiving and storing an image in the table.

FIG. 5A is a flow chart that illustrates execution of a query to read digital watermark information.

FIG. 5B is a flow chart that illustrates execution of a query to store and to associate digital watermark information with the image.

FIG. 6 is a flow chart that illustrates execution of a query to read the image.

### DETAILED DESCRIPTION

The term “multimedia data” as used in the context of this disclosure comprises a wide variety of complex data types, including data representing text, audio, video, images, and combinations thereof.

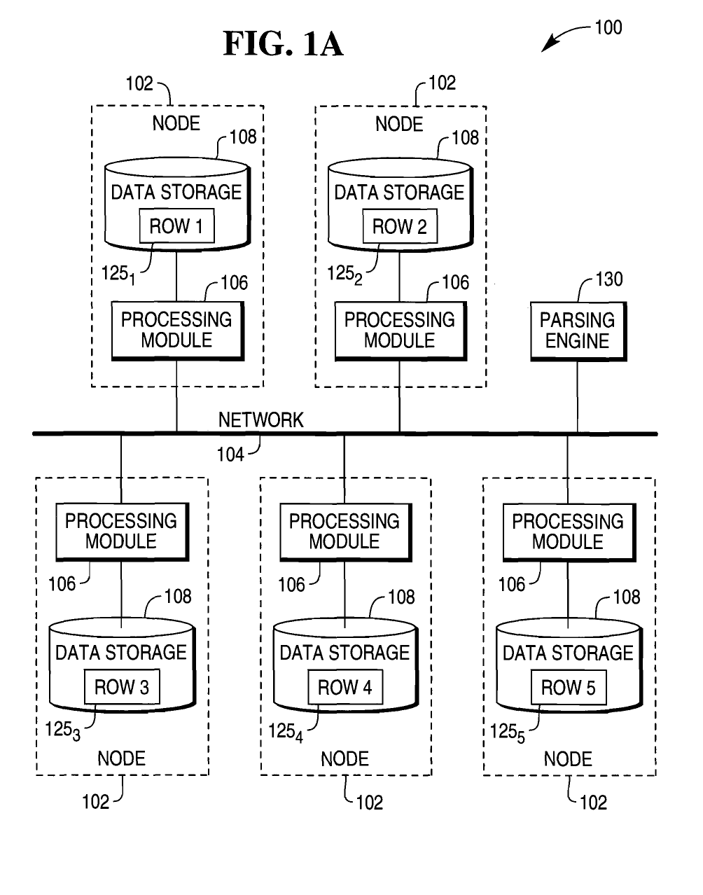

FIGS. 1A and 1B are block diagrams that illustrate an exemplary computer hardware and software environment 100 that is used to implement an Enterprise Data Warehouse (EDW) on a Relational Database Management System (RDBMS). The Teradata Active Data Warehousing System available from NCR Corporation is an example of such a system. The computer hardware and software environment 100 shown here is a massively parallel processing (MPP) computer system that includes one or more nodes 102 interconnected by a network 104. Within each of the nodes 102 is a processing module 106, which typically includes one or more physical processors 112; random access memory (RAM) 116; non-volatile memory 118; network communications hardware 110; and other components. Each of the physical processors 112 may also include multiple processor cores within each processor. In some systems, one or more data storage units (DSUs) 108 are attached to the processing module 106 through a storage controller 114. Typically, at least one of the nodes 102 also includes user interface components such as a monitor, a keyboard, and a mouse 120. A database administrator (DBA) is able to manage the RDBMS through the user interface components 120 in one of the nodes or by communicating over the network 104 to one of the nodes 102 having a user interface 120.

Each of the nodes 102 executes one or more computer programs, such as an operating system, Data Mining Applications performing data mining operations, Real-time Data Management (RTDM) Applications for performing operations on the data, Client Database Applications interacting with the database, and/or a Relational Database Management System (RDBMS) for managing a relational database stored across one or more of the DSUs. In some embodiments, a computer system having only a single node manages all or some subset of the computer programs.

The RDBMS stores data in one or more tables stored across the DSUs 108. The rows 125₁₋₅ of the tables are stored across multiple DSUs 108 in such a way as to ensure that the system workload is distributed evenly across the nodes 102. A parsing engine 130 organizes the storage of data and the distribution of table rows 125₁₋₅ among the Nodes 102 and DSUs 108. Large data objects (e.g., multimedia data) are sometimes stored separately from the rows 125₁₋₅ and tables. When this occurs, pointers to the data objects are stored in the rows 125₁₋₅ in place of the data objects. The parsing engine 130 also coordinates the retrieval of data from the DSUs 108 in response to queries. The queries for data and the commands that control the RDBMS are usually in a standard format, such as that prescribed by Structured Query Language (SQL) put forth by ANSI.

FIGS. 1A and 1B show an exemplar parallel database system but those skilled in the art will recognize that other systems such as a single processors system are suitable as well.

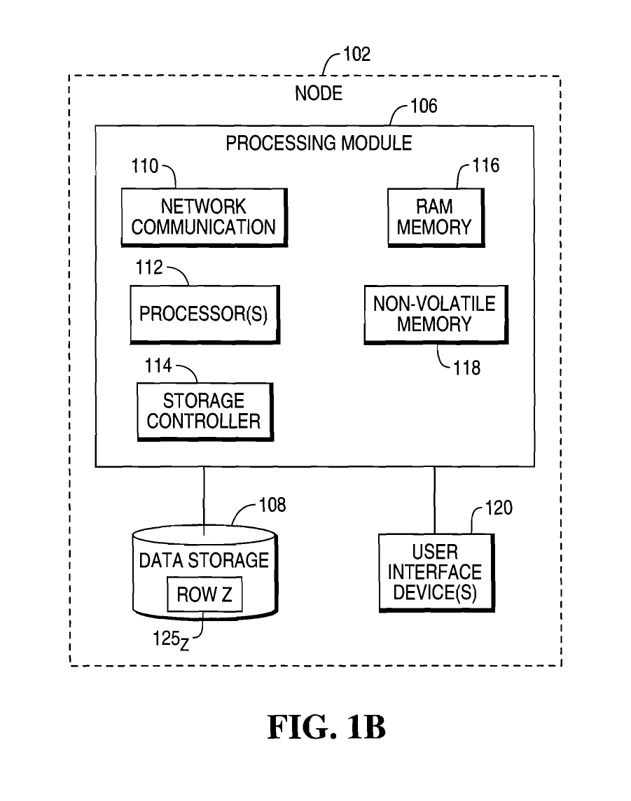

FIG. 2 illustrates an RDBMS 220 that supports digital watermarks. The RDBMS 220 is part of a larger data distribution system 200 that provides both local and world wide access to copyrighted data 225 stored in the RDBMS 220. The distribution system 200 uses a number of different methods to distribute the copyrighted data 225. In one method, copyrighted data 225 is retrieved from the RDBMS 220 and stored on fixed media such as CDs and DVDs 205, which are shipped to a final destination. In another method, copyrighted data 225 is directly retrieved from the RDBMS 220 by one or more client computers 240 communicating with the RDBMS 220 over to a local area network (LAN) 210. In yet another method, a web server 215 is used to allow client computers 235, attached to the Internet 230, to download copyrighted data 225 retrieved from the RDBMS 220.

The copyrighted data used in FIG. 2 consists of images that are typically stored in some standard format such as the JPG and GIF formats but almost any copyrightable data, in a standard format, could be used in a similar way. Examples of other data types include: text, image (e.g., BMP, GIF, PNG, JPG, TIFF, EMF, and WMF), audio (e.g., MP3 and WAV), video (e.g., MPEG, AVI, WMV, and ASF), and combinations of these data types (e.g., image and audio). Data of this type is sometimes referred to as multimedia data.

In other embodiments, the web server 215, the system for burning CDs and DVDs 205, and the database system 225 are applications and hardware that are part of a single computer system.

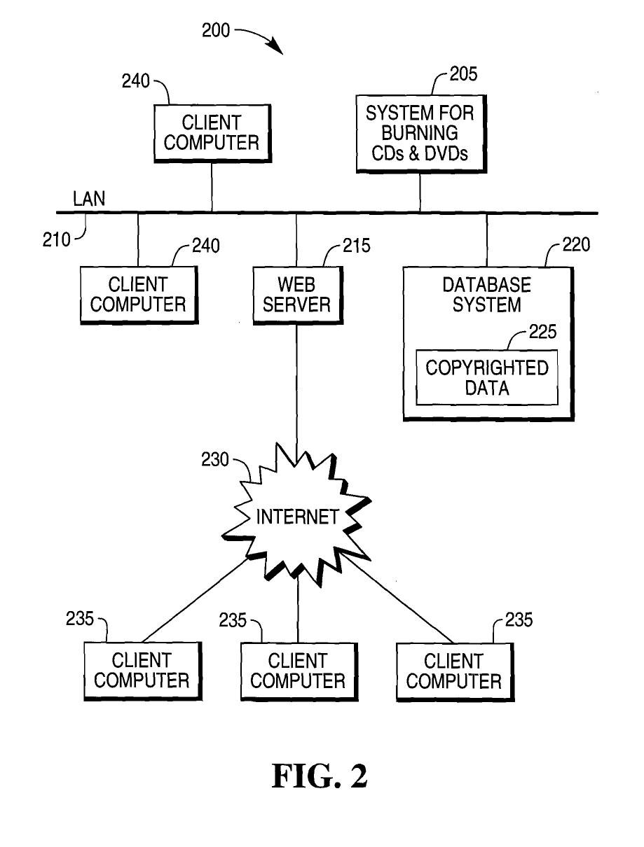

FIG. 3 illustrates a table 300 that is part of the RDBMS 220 shown in FIG. 2. RDBMS 220 supports both built-in and user defined data types (UDT). As part of the support for digital watermarks, the RDBMS 220 has two additional data types: “watermark information” and “watermark object.” A column created to store a “watermark information” data type contains information that has been recovered from a digitally watermarked object or information that will be embedded in a watermark object using a digital watermark. A column created to store a “watermark object” data type contains a data object that can be or has been digitally watermarked. A watermark object is a grouping of data (e.g., data that represents an image) that contains a digital watermark. In some embodiments, the “watermark object” column contains a pointer to data that is stored outside the table. A column defined as “watermark information” is associated with a column defined as “watermark object.”

In the example of FIG. 3, the table 300 has six columns: ID 305, TYPE 310, WATERMARK 315, TITLE 320, SIZE 325, and PHOTO 330. The table 300 also has four rows (340, 345, 350, and 355) each for storing a data object and related information. The ID column 305 contains a unique identifier for each row. The TYPE column 310 contains information that identifies the data format used to store the image. The WATERMARK column 315 contains the watermark information associated with the PHOTO 330 and has a data type of “watermark information.” If there is no watermark information associated with the image, a null is used. The TITLE column 320 contains a title or description of the photo. The SIZE column 325 contains the size in bytes of the photo. The PHOTO column 330 contains an image and has a data type of “watermark object.” In other embodiments, the image is stored outside the table 300 or outside the RDBMS 220 and a pointer to the image is stored in this column.

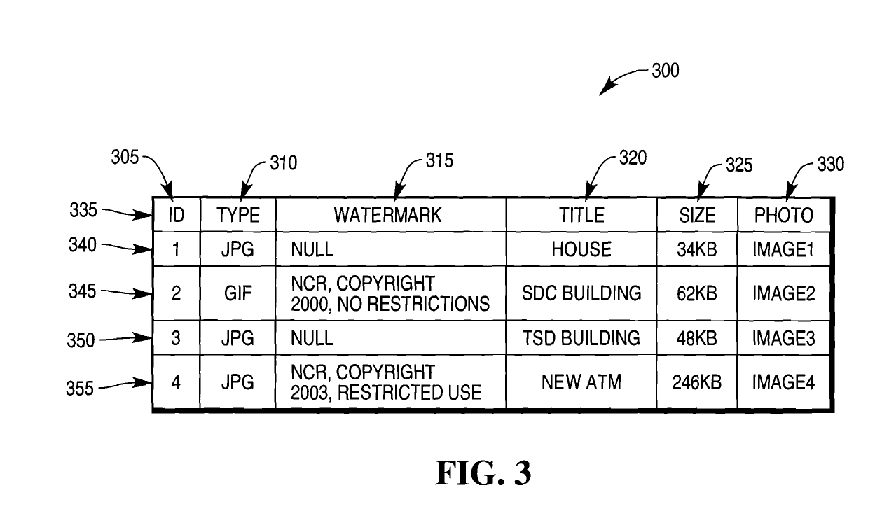

FIG. 4 shows the flow of operations in the RDBMS 220 when processing a query that includes an image to be stored in the table 300. Upon receiving an image 400, the database creates a new row in table (300) 405. The database then stores the received image in the PHOTO column 330 of the new row 410. Because the PHOTO column 330 has a data type of “watermark object,” the database continues processing the image to determine if a digital watermark has been stored in the image 430. If a digital watermark is found to be present in the image, it is recovered from the image and stored in the column labeled WATERMARK 315. (The digital watermark is stored in the WATERMARK 315 column because this column has a data type of “watermark information” and is associated with the PHOTO column 330.) If a digital watermark is not present in the image, a NULL is stored in the WATERMARK column 450.

There are numerous algorithms that implement digital watermarks. The details of how each algorithm functions is beyond the scope of this description. It is only necessary that the algorithms present a known interface to the database. In some databases, the database administrator will load one or more digital watermarking algorithms and assign each to a file or data type. The database will then use the appropriate digital watermarking algorithm for the data type being processed. In some cases, a user may direct that a specific digital watermark algorithm be used for a specific data object.

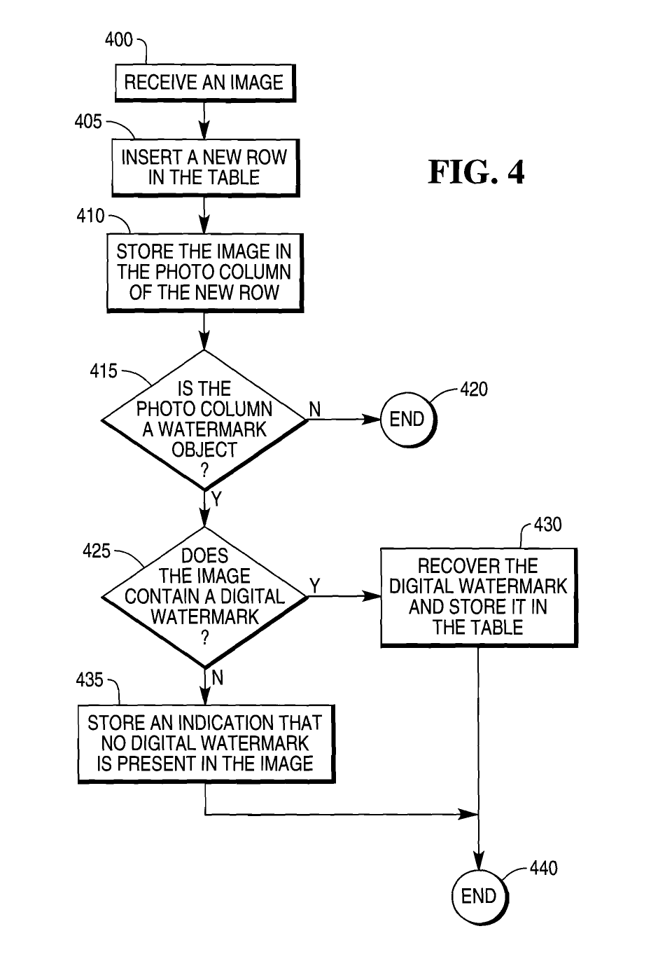

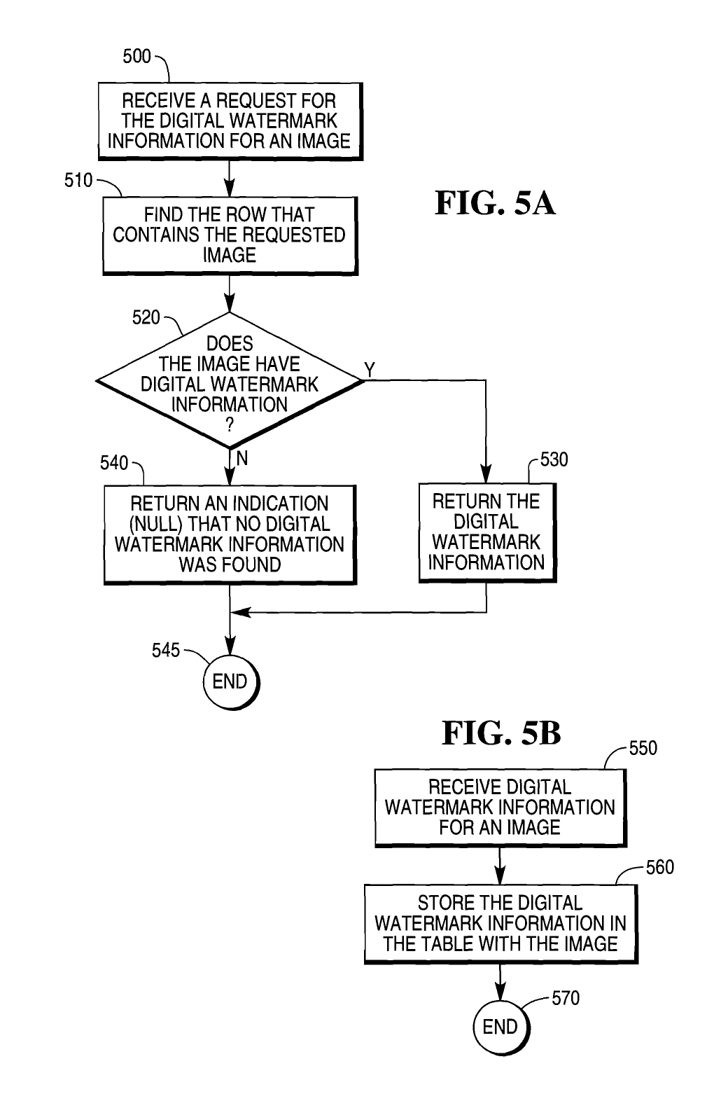

FIG. 5A shows the flow of operations in the RDBMS 220 when processing a request for digital watermark information. The RDBMS 220 receives a request for digital watermark information for a specific image 500. The RDBMS 220 then accesses the table 300, to find the row that contains the image 510. If the image contains a digital watermark 520, the RDBMS 220 returns the digital watermark information from the WATERMARK 315 column 530. If the image does not contain a digital watermark 520, the RDBMS 220 will return a NULL value 540. This process allows a user to access the information stored in the digital watermark or to determine that the image has not been digitally watermarked.

FIG. 5B shows the flow of operations in the RDBMS 220 when processing a request to store digital watermark information. The RDBMS 220 receives digital watermark information associated with an image 550. The RDBMS 220 then selects the row identified in the query and stores the digital watermark information in the WATERMARK column 315 of that row. This process is used to store digital watermarking information for data that does not already contain a watermark. In some embodiments, when a stored image contains a digital watermark, the digital watermark information that has been recovered and stored in the WATERMARK column 315 can not be changed or modified.

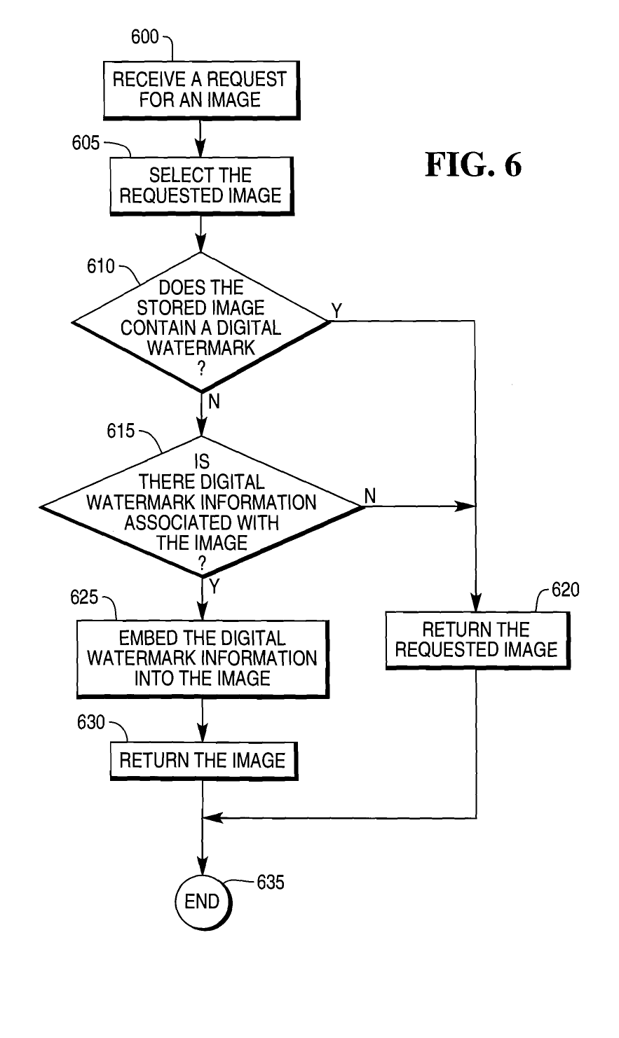

FIG. 6 shows the flow of operations in the RDBMS 220 when processing a request for an image from the table 300. Upon receiving a request for an image, the RDBMS 220 selects the requested image 605 and determines if the selected image contains a digital watermark 610. If the image does contain a digital watermark, it is returned 620 to the requester. If the image does not contain a digital watermark, the database determines whether the image has digital watermark information associated with it 615. If there is no digital watermark information, the image is returned without a digital watermark 620. Otherwise, the digital watermark information is embedded in the image 625 and the image, now containing a digital watermark, is returned 630.

In some embodiments, the RDBMS 220 supports a default watermark feature. This feature contains default digital watermark information that is defined by a user. The default digital watermark information is used to digitally watermark an image when no digital watermark information is specifically associated with the image. In these embodiments, when default digital watermark information is present, all images transferred out of the database will have a digital watermark containing either the default digital watermark information or the digital watermark information associated with each image. A clear image (an image without a digital watermark) can be read from the database if the following conditions are met: 1) the image stored in the database does not contain a digital watermark, 2) the image has no digital watermark information directly associated with it, and 3) the default digital watermark information is empty or the feature has been made inactive. In other embodiments, a security override feature will allow the database to return the original unaltered version of the image even though watermark information is present.

In some embodiments, the RDBMS 220 supports an additional feature that adds dynamic information to the digital watermark information prior to the image being digitally watermarked. The dynamic information includes: the current date, the name of the user requesting the image, copyright restrictions based on who is requesting the image, and other data related to the image. This feature allows the watermark information to be customized not only for each image but also for each retrieval of the image.

Using the described operations, the database will store an image and recover the digital watermark information that is embedded in the image. This information can then be read from the database and used to determine the owner of the image and whether or not the image has or is being used properly. In most cases, there is suffient information in the digital watermark to contact the owner of the image. Additionally, clear images—images without a digital watermark—can also be stored in the database. Digital watermark information can then be stored and associated with the image. The database will then embed the digital watermark information into the image each time it is accessed. Because the digital watermark is embedded each time the image is accessed, the information in the digital watermark can be modified as needed. For example, an image could be purchased with a restrictions that stated it can only be used on one web page for a period of time that ends on certain date. Information detailing the use restrictions would then be added to the digital watermark information and that information would be stored in the digitally watermarked image. At some point in the future, should a copy of the image be captured, the digital watermark information would be recovered and from the information in the digital watermark and from the circumstances surrounding the capture of the image, a determination would be made as to whether the image has been used properly (e.g., was the image taken from a web page it was not authorized to be used on).

In another embodiment, the images stored in the database are replaced with MP3 audio files. The database uses a different digital watermarking algorithms that is designed for use with MP3 data but the processes and features described above remain the same.

In still other embodiments, the images are replaced with different types of multimedia data. The multimedia data types include: MP3, WAV, MPEG, BMP, WMA, and others. The database will support any data type, as long as there is a digital watermark algorithm for that data type. In this case, the database supports multiple data types as one time.

The text above describes one or more specific embodiments of a broader invention. The invention also is carried out in a variety of alternative embodiments and thus is not limited to those described here. The various embodiments of the invention are realized in electronic hardware, computer software, or combinations of these technologies. Most embodiments include one or more computer programs executed by a programmable computer. For example, while the invention has been described here in terms of a RDBMS that uses a massively parallel processing (MPP) architecture, other types of database systems, including those that use a symmetric multiprocessing (SMP) architecture or even a single processor architecture, are also useful in carrying out the invention. The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

The computer programs include executable code that is usually stored in a persistent storage medium and then copied into memory at run-time. One or more processors executes the code by retrieving program instructions from memory in a prescribed order. When executing the program code, the computer receives data from the input and/or storage devices, performs operations on the data, and then delivers the resulting data to the output and/or storage devices.

What is claimed is:

1. A method for use in protecting data using digital watermarking in a computer-implemented database system, the method comprising:
storing a data object in a table in the database system;
identifying whether a first digital watermark is associated with the data object; and
when the first digital watermark is identified, storing the first digital watermark in the table separate.

2. The method of claim 1, further comprising:
receiving a query requesting an indication of whether the data object has an associated digital watermark; and
in response to the query, sending a reply indicating that the first digital watermark is associated with the object.

3. The method of claim 1, further comprising:
storing a second digital watermark in the table.

4. The method of claim 3, further comprising:
receiving a query requesting a copy of the data object.

5. The method of claim 4, further comprising:
in response to the query, returning a copy of the data object when the first digital watermark is identified.

6. The method of claim 4, further comprising;
in response to the query, returning a copy of the data object digitally watermarked using the second digital watermark, when the first digital watermark is not identified.

7. The method of claim 6, where dynamic information is embedded in the returned digitally watermarked copy.

8. The method of claim 3, further comprising:
digitally watermarking the data object using the second digital watermark, when the first digital watermark is not identified.

9. The method of claim 8, where digitally watermarking the data object includes embedding dynamic information.

10. The method of claim 1, where the data object comprises multimedia data.

11. The method of claim 1, where the data object comprises image data.

12. The method of claim 1, where the data object comprises audio data.

13. The method of claim 1, where storing the data object includes storing the data object outside the table and storing a pointer to the data object inside the table.

14. A program storage device, readable by a computer system, tangibly embodying one or more programs of instructions executable by the computer systems to perform a method for executing a query, the query being performed by the computer to store and retrieve data from a database that supports digital watermarking and is stored in one or more electronic storage devices coupled to the computer system, the method comprising:
storing a data object in the table;
detecting the presence of a first digital watermark associated with the data object; and
storing the first digital watermark associated with the data object in the table when the first digital watermark is present.

15. The program storage device of claim 14, wherein the method further comprises:
receiving a query requesting an indication of whether the data object has an associated digital watermark; and
in response to the query, sending a reply indicating that the first digital watermark is associated with the object.

16. The program storage device of claim 14, wherein the method further comprises:
storing the second digital watermark in the table.

17. The program storage device of claim 16, wherein the method further comprises:
receiving a query requesting a copy of the data object;

18. The program storage device of claim 17, wherein the method further comprises:
in response to the query, returning a copy of the data object when the first digital watermark is present.

19. The program storage device of claim 17, wherein the method further comprises:
in response to the query, returning a copy of the data object digitally watermarked using the second digital watermark when the first digital watermark is not present.

20. The program storage device of claim 19, where dynamic information is embedded in the returned digitally watermarked copy.

21. The program storage device of claim 16, wherein the method further comprises:
digitally watermarking the stored data object using the second digital watermark when the first digital watermark is not present.

22. The program storage device of claim 21, where digitally watermarking the stored data object includes embedding dynamic information.

23. The program storage device of claim 14, where the data object comprises multimedia data.

24. The program storage device of claim 14, where the data object comprises image data.

25. The program storage device of claim 14, where the data object comprises audio data.

26. The program storage device of claim 14, where storing the data object includes storing the data object outside the table and storing a pointer to the data object in the table.

27. A database system including:
one or more processors,
a storage accessible by at least one of the one or more processors; and
instructions executable by at least one of the one or more processors, enabling the system to:
store a data object on the storage;
detect the presence of a first digital watermark embedded in the data object;
store the first digital watermark embedded in the data object in the table when the first digital watermark is detected.

28. The database system of claim 27, further comprising instructions to:
receiving a query requesting an indication of whether the data object has an associated digital watermark; and
in response to the query, sending a reply indicating that the first digital watermark is associated with the object.

29. The database system of claim 27, further comprising instructions to:
store the second digital watermark in the table.

30. The database system of claim 29, further comprising instructions to:
receive a query requesting a copy of the data object.

31. The database system of claim 30, further comprising instructions to:
in response to the query, return a copy of the data object when the first digital watermark is present.

32. The database system of claim 30, further comprising instructions to:
in response to the query, return a copy of the data object digitally watermarked using the second digital watermark when the first digital watermark is not present.

33. The database system of claim 32, where dynamic information is embedded in the returned digitally watermarked copy.

34. The database system of claim 29, further comprising instructions to:
digitally watermarking the stored data object using the second digital watermark when the first digital watermark is not present.

35. The database system of claim 34, where digitally watermarking the stored data object includes embedding dynamic information.

36. The database system of claim 27, where the data object comprises multimedia data.

37. The database system of claim 27, where the data object comprises image data.

38. The database system of claim 27, where the data object comprises audio data.

39. The database system of claim 27, where storing the data object includes storing the data object outside the table and storing a pointer to the data object inside the table.
